(19) United States
(12) Patent Application Publication
(10) Pub. No.: US 2015/0192065 A1
(43) Pub. Date: Jul. 9, 2015

(54) PROCESS AND APPARATUS FOR GENERATING ELECTRIC ENERGY

(71) Applicant: LINDE AKTIENGESELLSCHAFT, MUNCHEN (DE)

(72) Inventor: Alexander Alekseev, Wolfratshausen (DE)

(73) Assignee: LINDE AKTIENGESELLSCHAFT, MUNCHEN (DE)

(21) Appl. No.: 14/409,006

(22) PCT Filed: Jun. 25, 2013
(86) PCT No.: PCT/EP2013/001864

§ 371 Date: Dec. 18, 2014

(30) Foreign Application Priority Data
Jun. 28, 2012 (EP) 12004833.5

(51) Int. Cl. F02C 3/22; F25J 1/00; F02C 1/02

(52) U.S. Cl. CPC F02C 3/22; F02C 1/02; F25J 1/0017; F25J 2260/30; F25J 2240/10

(57) ABSTRACT

The invention provides a process and apparatus to generate electric energy in a system comprising a power station and air treatment plant. The power station has a first gas expansion unit connected to a generator. The air treatment plant has an air compression unit, heat exchanger system and tank for liquid. In a first operating mode, feed air is compressed in the air compression unit and cooled in the heat exchanger system. A storage fluid containing less than 40 mol % of oxygen is produced and stored as low-temperature liquid in the tank for liquid. In a second operating mode, low-temperature liquid is taken from the tank for liquid and vaporized or pseudovaporized under superatmospheric pressure. The gaseous high-pressure storage fluid produced in this way is expanded in a gas expansion unit. The (pseudo)vaporization of the low-temperature liquid is carried out in the heat exchanger system of the air treatment plant.

The invention relates to a method and an apparatus for generating electrical energy, in accordance with the preamble of claim 1, and to a corresponding apparatus.

A “cryogenic liquid” is understood as a liquid whose boiling point is below ambient temperature and is for example 200 K or lower, in particular lower than 220 K.

The cryogenic liquid may, during “vaporization”, be under subcritical pressure. However, if the cryogenic liquid is brought to a hyperbaric pressure which is above the critical pressure, there is no real phase change (“vaporization”), but what is termed “pseudo-vaporization”.

The “heat exchanger system” serves to cool feed air for the air treatment plant via indirect exchange of heat with one or more cold flows. It may be formed from a single heat exchanger section or multiple heat exchanger sections connected in parallel and/or in series, for example from one or more plate heat exchanger blocks.

Methods and apparatuses are known which use liquid air or liquid nitrogen for network controlling and for providing control power in power grids. In that context, during times of cheap power, ambient air is liquefied in an air fractionation plant with an integrated liquefier or in a separate liquefaction plant, and is stored in a liquid tank formed as a cryogenic store. At times of peak load, the liquefied air is extracted from the store and its pressure is raised in a pump; it is then heated to around or above ambient temperature. This hot high-pressure air is then expanded to ambient pressure in an expansion unit consisting of a turbine or multiple turbines with intermediate heating. The mechanical energy produced in the turbine unit is converted to electrical energy in a generator and is fed into the electrical grid as particularly valuable energy. Such systems are described in WO 2007096656 and in DE 3139567 A1.

Such methods may, as is also the case for the method of the invention, fundamentally also be carried out with a storage fluid containing 40 mol % or more of oxygen. In this case, however, the latter has been excluded in order to avoid confusion with systems in which a particularly oxygen-rich fluid is introduced in order to support oxidation reactions in a gas turbine system.

A method of the type mentioned in the introduction and a corresponding apparatus are known from US 2009293502 A1. Here, during the second operating mode, the cryogenic liquid is not introduced into a separate heat exchanger and for example vaporized or pseudo-vaporized against atmospheric air or hot steam; rather, this step is carried out in the heat exchanger system of the air treatment plant which is in any case present for cooling the feed air in the first operating mode. In the second operating mode, too, feed air is compressed in the air compression unit and is cooled in the heat exchanger system. This generates the heating medium necessary for vaporizing the stored cryogenic liquid. The air treatment plant, in which the cryogenic liquid is produced in the first operating mode is formed as an air liquefaction plant, that is to say in this case feed air is used not primarily for the production of its constituents oxygen and/or nitrogen by cryogenic fractionation; rather, all of the feed air—or at least the majority thereof—is liquefied in the first operating mode and is obtained as a cryogenic liquid without fractionation.

Within the scope of the invention, similar to in US 2009293502 A1, in the second operating mode mechanical energy is generated from the high-pressure storage fluid, in that either the storage fluid itself or a fluid derived therefrom is expanded in the gas expansion unit so as to perform work. The fluid derived therefrom may for example consist of a mixture of the storage fluid with one or more other fluids, or of a reaction product of the storage fluid with one or more other substances. The latter may for example consist of combustion exhaust gas if the storage fluid contains oxygen and is used for the combustion of a fuel.

The invention is based on the object of improving such a system with respect to its profitability and in particular of making a relatively simple construction of the apparatus possible.

This object is achieved with the characterizing features of claim 1. According to the invention, therefore, in the second operating mode, the feed air compressed in the air compression unit is at least partially not liquefied but undergoes as auxiliary air a further compression in at least one cold compressor and is then mixed in with the gaseous high-pressure storage fluid. Thus, substantially more high-pressure gas is available for the expansion in the gas expansion unit than is obtained through the vaporization, and accordingly more electrical energy can be obtained in the second operating mode.

It may at first appear disadvantageous to additionally operate one or more cold compressors in the second operating mode, during which the energy price is high. Within the scope of the invention, however, it has surprisingly been found that, by means of the additional quantity of high-pressure gas, so much additional electrical energy can be obtained that overall an economically particularly advantageous system results. Conversely, for the same maximum quantity of energy which can be generated in the second operating mode, a large proportion of the plant parts can be made smaller and thus more cost-effectively. At the same time, less energy is used in the second operating mode.

Preferably, the auxiliary air is further compressed in at least two cold compressors, which are connected in parallel. Thus, this compression step is performed particularly efficiently; furthermore, the quantity of auxiliary air can be flexibly adapted to the current requirement. The two cold compressors may have the same inlet temperature, although their inlet temperatures are preferably different. For example, these inlet temperatures for the cold compressors differ by at least 10 K, preferably by more than 30 K.

In a first variant of the method according to the invention, in the second operating mode at least part of the production of electrical energy from the gaseous high-pressure storage fluid is performed in the gas turbine expander of a gas turbine system of a gas turbine power station, wherein the storage fluid is fed to the gas turbine system downstream of the vaporization. The gas turbine system is then part of the gas expansion unit within the sense of claim 1. This use of the gas turbine system itself for obtaining energy from the high-pressure storage fluid is described in more detail in claims 5 and 6 and in the prior German patent application 102011121011 and the patent applications corresponding thereto.

A “gas turbine system” has a gas turbine (gas turbine expander) and a combustion chamber. In the gas turbine, hot gases from the combustion chamber are expanded so as to perform work. The gas turbine system may also have a gas turbine compressor driven by the gas turbine. Part of the mechanical energy generated in the gas turbine is commonly used to drive the gas turbine compressor. A further part is generally converted in a generator to generate electrical energy.

In this variant, at least part of the generation of mechanical energy from the gaseous high-pressure storage fluid takes place in the gas turbine system of the power station, that is to say in equipment, in any case present in the power station, for converting pressure energy into mechanical drive energy. Within the scope of the invention, an additional separate system for the work-performing expansion of the high-pressure storage fluid may be of less complex design or may be omitted entirely. In the simplest case, it is possible within the scope of the invention for all the generation of mechanical energy from the gaseous high-pressure storage fluid to be undertaken in the gas turbine system. The high-pressure storage fluid is then fed, for example below that pressure at which it is (pseudo-)vaporized, to the gas turbine system.

In a second variant, the gas expansion unit has a hot-gas turbine system which has at least one heater and one hot-gas turbine. The generation of electrical energy from the gaseous high-pressure storage fluid is then carried out at least partially as work-performing expansion in a hot-gas turbine system which has at least one heater and one hot-gas turbine. Here, the generation of energy from the high-pres sure storage fluid takes place outside the gas turbine system.

The “hot-gas turbine system” may be formed as a single stage with a heater and a single-stage turbine. Alternatively, it may have multiple turbine stages, preferably with intermediate heating. It is in any case expedient to provide a further heater downstream of the last stage of the hot-gas turbine system. The hot-gas turbine system is preferably coupled to one or more generators for generating electrical energy.

A “heater” is understood here as a system for the indirect exchange of heat between a heating fluid and the gaseous storage fluid. It is thus possible to transfer residual heat or waste heat to the storage fluid and to use this heat for generating energy in the hot-gas turbine system.

The two variants of the invention may also be combined, in that the gas expansion unit has one or more hot-gas turbines as well as one or more gas turbine systems. The gaseous high-pressure storage fluid is then expanded in two steps, wherein the first step is carried out as a work-performing expansion in the hot-gas turbine system and the second step is carried out in the gas turbine system, wherein the gaseous high-pressure storage fluid is fed to the hot-gas turbine system where it is expanded to a medium pressure, and a gaseous medium-pressure storage fluid is extracted from the hot-gas turbine system and is finally fed to the gas turbine system.

Preferably, in the first operating mode, at least part of the compressed feed air from the air compression unit is cooled in the same passages of the heat exchanger system which, in the second operating mode, are used for vaporizing or pseudo-vaporizing. In particular, in the first operating mode, at least 50 mol %, in particular at least 80 mol % or at least 90 mol % of the feed air flows through these shared passages.

The invention also relates to an apparatus for generating energy according to claim 7 or 8. An “automatic control device” is in this case to be understood to be an apparatus which at least automatically controls the system during the first operating mode and during the second operating mode. It is preferably capable of automatically carrying out the transition from the first to the second operating mode and vice versa. The apparatus according to the invention may be complemented by apparatus features which correspond to the features of the dependent method claims.

The invention and further details of the invention will in the following be described in more detail with reference to exemplary embodiments represented in the drawings, in which:

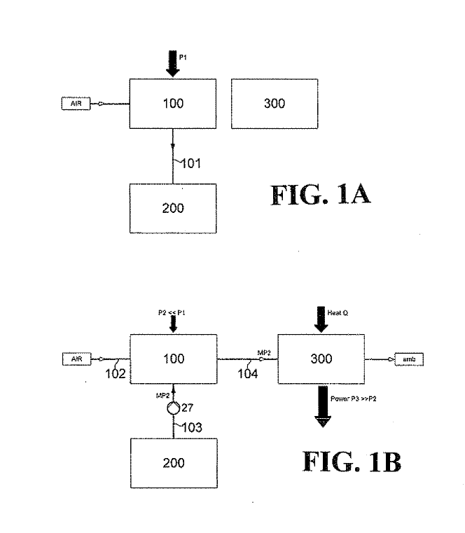

FIGS. 1a and 1b show the basic principle of the invention, respectively in the first and second operating mode,

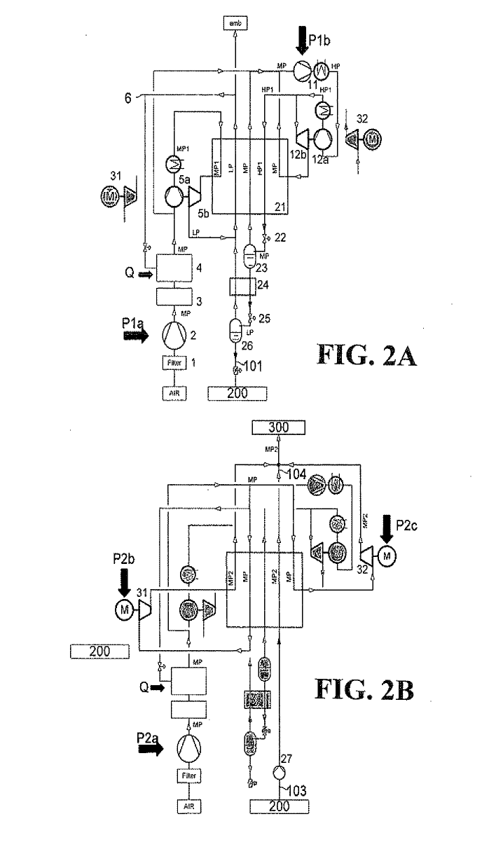

FIGS. 2a and 2b show an embodiment for an air treatment plant by means of which the invention can be realized,

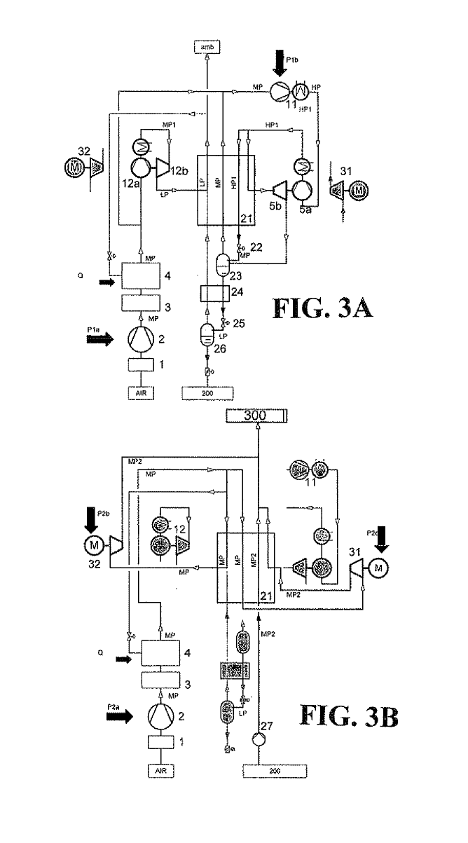

FIGS. 3a and 3b show a further embodiment of an air treatment plant in both operating modes, and

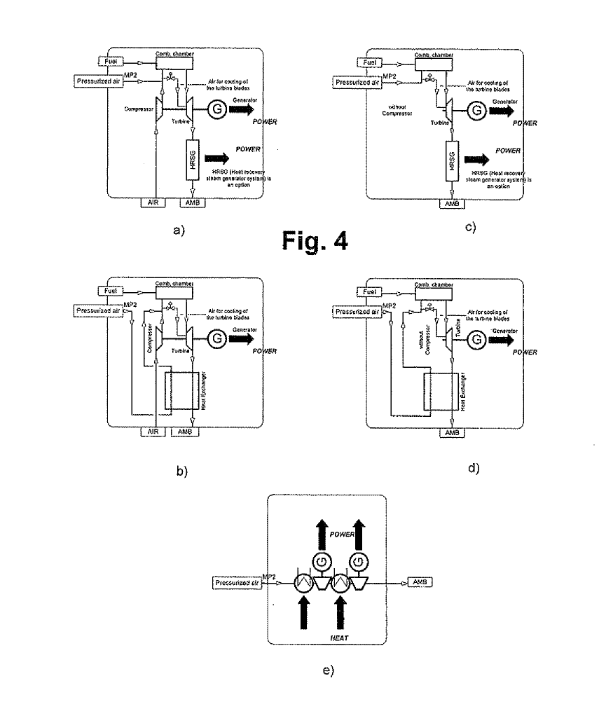

FIG. 4 shows possible embodiments of the gas expansion unit.

The overall plant of FIGS. 1a and 1b consists of three units: an air treatment plant 100, a liquid tank 200 and a gas expansion unit 300.

FIG. 1a shows the first operating mode (cheap electricity phase—generally at night). In this context, atmospheric air (AIR) is introduced into the air treatment plant 100 as feed air. A cryogenic liquid 101, which is for example formed as liquid air, is produced in the air treatment plant. The air treatment plant is operated as a liquefier (in particular as an air liquefier). The cryogenic liquid 101 is introduced into the liquid tank 200 which is operated at a low pressure LP of less than 2 bar. The energy consumption of the air treatment plant in the first operating mode is labeled P1.

FIG. 1b shows the second operating mode (peak current phase—generally during the day). In this case, the air treatment plant functions as a vaporizer. The cryogenic liquid 103 (for example liquid air) is extracted from the liquid tank 200, introduced into a pump at an elevated pressure MP2 (greater than 12 bar, for example approx. 20 bar), vaporized in the air treatment plant and heated to approximately ambient temperature. The (pseudo-)vaporization and the heating then use the same passages of the heat exchanger system 21 that in the first operating mode serve for cooling the feed air to be liquefied. The heat required for the vaporization is provided by an additional flow 102 of feed air, which is sucked in from the surroundings. With the aid of the additional air flow, it is possible not only to vaporize and heat the liquid air but also to compress the additional air flow to the pressure MP2 (for details see FIG. 2b below). Thus, accordingly more high-pressure gas is available as a vehicle for energy, wherein an energy expenditure P2 is required and the cold of the vaporizing liquid is used. The vaporized high-pressure storage fluid and the additional air which has been brought up to pressure are together fed to the gas expansion unit 300 via line 104. The power P2 in the second operating mode is for example 20 to 70%, preferably 40 to 60% of the power P1 in the first operating mode.

This connection scheme ensures that the quantity of compressed air which is fed to the expansion is substantially greater than the quantity which is extracted from the liquid air store 200, since the additional air is mixed with this quantity. Thus, substantially more air is fed into the gas expansion unit 300 and the power P3 generated there is substantially increased (P3>>P2). Depending on the configuration of the compressed air expansion unit (see FIG. 4), P3 can reach values which are comparable with P1.

The production of the cryogenic liquid and the vaporization of the cryogenic liquid are normally carried out in two different process units. In the context of the invention, it has been possible to configure the method such that these process units can be merged to a substantial extent.

FIGS. 2a and 2b show an embodiment for an air treatment plant by means of which the invention can be realized.

FIG. 2a relates to the first operating mode. Here, ambient air (AIR) is sucked in by an air compression unit 2 and compressed to a pressure MP (4 to 8 bar, in particular 5 to 6 bar); it is then cooled in a pre-cooling device 3 and is dried in a molecular sieve adsorber station 4 and purified from contaminants such as CO₂ and hydrocarbons. The air is then split into two flow portions.

A first part of the compressed and purified air is further compressed, in a first single-stage post-compressor (booster) 5a, to a pressure MP1>MP2 (MP1=6 to 15 bar), is cooled in an aftercooler to approximately ambient temperature, after which it is cooled in the heat exchanger system 21 to an intermediate temperature of 140 to 180 K; in a first, cold turbine 5b, it is then expanded, so as to perform work, to a low pressure LP (<2 bar, in particular approximately 1.4 bar). The cold turbine 5b drives the first post-compressor 5a via a common shaft. The first part of the feed air, expanded so as to perform work, is fed, at the pressure LP, through the heat exchanger system 21, where it is heated. At the hot end of the heat exchanger system 21, part of this air is released to the surroundings (amb). Another part 6 is used as regenerating gas for the molecular sieve adsorber station. The regenerating gas is heated by steam, an electric heater or natural gas firing (quantity of heat Q). A second part of the compressed and purified air is fed to a separate compressor, the circuit compressor 11, where it is first compressed from the pressure MP to a higher pressure HP of 20 to 40 bar; it is then cooled in an aftercooler to approximately ambient temperature and is subsequently further compressed, in a second single-stage post-compressor (booster) 12a, to the still higher pressure HP1 of 40 to 80 bar (and is then once again cooled in an aftercooler to approximately ambient temperature).

Part of the high-pressure air at HP1 is then expanded, so as to perform work, to the pressure MP in a second turbine 12b. The inlet temperature of the second turbine 12b is higher than that of the first turbine, such that the second turbine is also referred to as the “warm” turbine. As represented, the air can be fed directly into the second turbine 12b; alternatively, it is first cooled somewhat in the heat exchanger system 21. During the work-performing expansion, the air cools down. It is then fed, at the pressure MP, through the heat exchanger system to the suction pipe of the circuit compressor 11. A flow portion (Joule-Thomson flow, sometimes also referred to as throttling flow) is fed, at the highest pressure HP1, through the heat exchanger system as far as the cold end and is then expanded (22) in a separator 23 which is operated at the pressure MP. Here, the steam fraction is separated off from the liquid and fed through the heat exchanger system 21 to the suction pipe of the circuit compressor. The liquid separated off is further cooled in a subcooler 24 and is then expanded (25) to the required low pressure in the separator 26. The steam fraction is also separated off here and is sent, together with the air from the cold turbine 5b, through the heat exchanger system 21; the liquid fraction forms the “cryogenic liquid” and is fed into the liquid tank 200.

In the first operating mode, energy P1=P1a+P1b is supplied, in the form of the drive powers P1a for the air compression unit and P1b for the circuit compressor, and the quantity of heat Q for heating the regenerating gas. No energy is removed (except via the aftercoolers of the compressors); rather, energy is stored in the form of the cryogenic liquid air in the liquid tank 200.

The second operating mode will now be described with reference to FIG. 2b. Here, the two turbines 5b and 12b, the circuit compressor 11 and the Joule-Thomson stage (the two throttling valves 22 and 25, the two separators 23 and 26 and the subcooler 24) are switched off and two cold compressors 31 and 32 are connected to the corresponding pipes of the heat exchanger.

Liquid air (LAIR) 103 is extracted from the liquid tank 200, is raised to a hyperbaric pressure MP2 in the pump 27 (here >12 bar) and is vaporized in the heat exchanger system 21 of the air treatment plant to give a gaseous high-pressure storage fluid 104.

The heat necessary for the vaporization is provided by another additional air flow, referred to here as “auxiliary air”. Similarly to the first operating mode, it is sucked in from the surroundings as feed air, compressed in the air compression unit 2 to the pressure MP, pre-cooled (3) and is dried in a molecular sieve adsorber station 4 and purified from contaminants such as CO₂ and hydrocarbons. This auxiliary air is then split into two flow portions. Both flow portions are cooled in the heat exchanger system by the vaporizing liquid air, a first flow portion to an intermediate temperature of 140 to 180 K and the other to between 90 and 120 K, and are further compressed in the cold compressors 31 or 32 to the pressure MP2. The air from the colder cold compressor 31 is fed through the heat exchanger system before it is mixed with the vaporized liquid air and the compressed air from the warmer cold compressor 32. The air mixture at the pressure MP2 is fed to the gas expansion unit 300.

In the case of this method implementation, the air compression unit 2 need not be switched off even in the second operating mode, but runs constantly—both in the first and in the second operating mode. The heat exchanger system 21 of the air treatment plant is used both for the liquefaction (in the first operating mode) and for the (pseudo-)vaporization (in the second operating mode).

In the second operating mode, energy P2=P2a+P2b+P2c is supplied, in the form of the drive powers P2a for the air compression unit and P2b and P2c, respectively, for the two cold compressors 31, 32, and the quantity of heat Q for heating the regenerating gas. Energy is removed (except via the aftercoolers of the compressors) in the form of the compressed air flow at the pressure MP2 to the gas expansion unit 300.

The connection scheme in FIGS. 3a and 3b differs from the preceding one in that the “cold” turbine/post-compressor combination 5a/5b is connected downstream of the circuit compressor, between the pressures HP1 and MP. The “warm” turbine/post-compressor combination 12a/12b, however, receives air direct from the air compression unit 2 and expands it accordingly to the low pressure LP. The air compression unit 2 and the air purification 3 can thus be made somewhat smaller than in FIGS. 2a and 2b.

FIG. 4 shows possible embodiments of the gas expansion unit 300. In embodiments 4a and 4b, a conventional gas turbine is used for the expansion, the compressed air from the air treatment plant is introduced into the gas turbine upstream of the combustion chamber. The heat of the flue gas at the outlet can be used in a heat recovery steam generator (HRSG) (4a); alternatively, it is used in another way, for example to preheat the compressed air from the air treatment plant (4b).

In embodiments 4c and 4d, a converted gas turbine is used for the expansion; in this gas turbine, the compressor part is removed. The compressed air from the air treatment plant is introduced into the combustion chamber of the rest of the gas turbine. The heat of the flue gas can be used in a similar manner to the method with the gas turbine.

In embodiment 4e, the compressed air from the air treatment plant is first heated and expanded in multiple series-connected turbines/turbine stages; the air is additionally heated between the individual expansion stages. This represents an exemplary embodiment for a gas expansion unit having a hot-gas turbine system which has at least one heater and one hot-gas turbine—in this case there are respectively two heaters and hot-gas turbines; alternatively, the hot-gas turbine system may also have more than two stages.

The embodiment variants 4a and 4b, and 4c and 4d, may be combined with one another.

1. A method for generating electrical energy in a combined system consisting of a power station and an air treatment plant, wherein the power station has a first gas expansion unit (300) which is connected to a generator for generating electrical energy, and the air treatment plant is formed as an air liquefaction plant and has an air compression unit (2), a heat exchanger system (21) and a liquid tank (200), and wherein
in a first operating mode
in the air treatment plant
feed air is compressed in the air compression unit (2) and is cooled in the heat exchanger system (21),
a storage fluid, containing less than 40 mol % oxygen, is produced from the compressed and cooled feed air,
the storage fluid is stored in the liquid tank (200) as a cryogenic liquid (101), wherein the cryogenic liquid (101) is formed from liquefied air,
and in a second operating mode
cryogenic liquid (103) is extracted from the liquid tank (200) and is vaporized or pseudo-vaporized under hyperbaric pressure, and the gaseous high-pressure storage fluid (104) thus generated is expanded in the gas expansion unit (300),
wherein, in the second operating mode, the cryogenic liquid is (pseudo-)vaporized in the heat exchanger system (21) of the air treatment plant and,
also in the second operating mode, feed air is compressed in the air compression unit (2),
characterized in that, in the second operating mode, compressed feed air from the air compression unit (2) undergoes as auxiliary air a further compression in at least one cold compressor (31, 32) and is then mixed in with the gaseous high-pressure storage fluid (104).

2. The method as claimed in claim 1, characterized in that the auxiliary air is further compressed in at least two cold compressors (31, 32), which are connected in parallel.

3. The method as claimed in claim 1, characterized in that the power station has a gas turbine system with combustion chamber, gas turbine expander and generator, and at least part of the gaseous high-pressure storage fluid (104) is expanded in the gas turbine expander of a gas turbine system, wherein the storage fluid (104) is fed to the gas turbine system downstream of the (pseudo-)vaporization (21).

4. The method as claimed in claim 1, characterized in that the gas expansion unit has a hot-gas turbine system which has at least one heater and one hot-gas turbine.

5. The method as claimed in claim 3, characterized in that the gaseous high-pressure storage fluid is expanded in two steps, wherein the first step is carried out as a work-performing expansion in the hot-gas turbine system and the second step is carried out in the gas turbine system, wherein the gaseous high-pressure storage fluid is fed to the hot-gas turbine system where it is expanded to a medium pressure, and a gaseous medium-pressure storage fluid is extracted from the hot-gas turbine system and is finally fed to the gas turbine system.

6. The method as claimed in claim 1, characterized in that, in the first operating mode, at least part of the compressed feed air from the air compression unit (2) is cooled in the same passages of the heat exchanger system (21) which, in the second operating mode, are used for vaporizing or pseudo-vaporizing.

7. An apparatus for generating electrical energy with a combined system consisting of a power station and an air treatment plant, wherein the power station has a first gas expansion unit (300) which is connected to a generator for generating electrical energy, and the air treatment plant is formed as an air liquefaction plant and has an air compression unit (2), a heat exchanger system (21) and a liquid tank (200), wherein the apparatus has an automatic control device and pipes and control elements, wherein the control device is formed such that the apparatus can be operated in a first and in a second operating mode, wherein
in a first operating mode
in the air treatment plant
feed air is compressed in the air compression unit (2) and is cooled in the heat exchanger system (21),
a storage fluid, containing less than 40 mol % oxygen, is produced from the compressed and cooled feed air,
the storage fluid is stored in the liquid tank (200) as a cryogenic liquid (101), wherein the cryogenic liquid (101) is formed from liquefied air,
and in a second operating mode
cryogenic liquid (103) is extracted from the liquid tank (200) and is vaporized or pseudo-vaporized under hyperbaric pressure, and the gaseous high-pressure storage fluid (104) thus generated is expanded in the gas expansion unit (300),
wherein, in the second operating mode, the cryogenic liquid is (pseudo-)vaporized in the heat exchanger system (21) of the air treatment plant and,
also in the second operating mode, feed air is compressed in the air compression unit (2),
characterized in that the control device is formed such that, in the second operating mode, compressed feed air from the air compression unit (2) undergoes as auxiliary air a further compression in at least one cold compressor (31, 32) and is then mixed in with the gaseous high-pressure storage fluid (104).

8. The apparatus as claimed in claim 7, characterized by at least two cold compressors (31, 32), which are connected in parallel, for further compressing the auxiliary air.
